(19) United States
(12) Patent Application Publication
(10) Pub. No.: US 2024/0416609 A1
(43) Pub. Date: Dec. 19, 2024

(54) DEVICES AND METHODS FOR PRODUCING DOUBLE WALL RECYCLABLE CUPS

(71) Applicant: Tse Huang KUO, Taipei (TW)

(72) Inventor: Tse Huang KUO, Taipei (TW)

(21) Appl. No.: 18/210,086

(22) Filed: Jun. 15, 2023

(51) Int. Cl. B31B 50/59

(52) U.S. Cl. CPC B31B 50/592

(57) ABSTRACT

Disclosed herein is a press device for coupling two cups respectively made of a first and a second materials and are stacked together to form a double wall cup after pressing. The press device comprises an upper mold and a lower mold; in its structure, the upper mold includes a first hollow cylinder and a second hollow cylinder that can move vertically inside the first hollow cylinder; and the lower mold comprises a third hollow cylinder for accommodating and holding the two cups and a push rod centrally disposed within the third hollow cylinder for pushing up the two cups. The press device does not include any alignment structure for positioning the two cups. Also encompassed in the present disclosure is a method for coupling the two cups by utilizing the present press device, and the coupling method does not include any step of rotating or positioning the two cups.

### BACKGROUND OF THE INVENTION

### 1. Field of the Invention

The present disclosure relates to a device and a method for producing double wall cups. More particularly, the disclosed invention relates to a device and a method for producing a double wall recyclable cup by coupling an outer cup, and an inner cup characterized in having an extension tab extending from the rim of the inner cup.

### 2. Description of Related Art

Disposable cups are widely used nowadays, thus, the task in recycling disposable cups becomes increasingly more challenging. Many techniques have been developed to address this issue, one of which involves using double-layer cups made of different materials that can be easily separated for recycling after use.

US Patent No. U.S. Pat. No. 9,301,630B2 is directed to a disposable cup that comprises an outer paper cup and an inner plastic cup with an extension sheet extending from the curled edge of the inner plastic cup and integrally formed with it. Pulling up the extension sheet away from the cup bottom enables separation of the inner plastic cup and the outer paper cup, facilitating complete recycling of the disposable cup after use. However, this approach not only requires considering the ease of separation but also the tightness and stability of the engagement between the inner and outer cups during use.

To ensure the inner and outer cups are tightly engaged, a press device consisting of upper and lower molds is used during cup production to curl and press the rims of the inner plastic and outer paper cups together. However, the extension sheet on the inner plastic cup would interfere with the pressing process and cause delays in production. While adding a notch to the press device to provide precise alignment of the extension sheet may help, it would also require an additional step of rotating the cup to fit into the notch, which would inevitably slow down the production process.

In view of the foregoing, there is a need in the relevant art for an improved pressing device that is not affected by any protrusion of the cup rim and is capable of smoothly coupling the inner and outer cups regardless of the position of the extension sheet.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

As embodied and broadly described herein, the purpose of the present disclosure is to provide a press device and a coupling method that utilize the press device to engage two cups, wherein one of the cups has an irregular rim, especially a tab extending from the rim, with the goal of significantly enhancing production efficiency.

In one aspect, the present disclosure is directed to a press device comprising an upper mold and a lower mold that are vertically aligned for coupling two cups respectively made of a first and a second materials and are stacked together to form a double wall cup after pressing. In the press device, the upper mold in structure comprises a first hollow cylinder and a second hollow cylinder, and the lower mold comprises a third hollow cylinder and a push rod. The second hollow cylinder of the upper mold moves vertically and independently inside the first hollow cylinder; on the other hand, the third hollow cylinder accommodates and holds the two cups, and the push rod is disposed at the center of the third hollow cylinder for pushing up the two cups.

According to the present aspect, the second hollow cylinder has a flange protruding from the outer surface of the second hollow cylinder and contacting the inner surface of the first hollow cylinder, thereby defining a space therebetween for accommodating at least the rims and portions of the cup bodies of the two cups, and the third hollow cylinder has a curling groove disposed at and around the top edge of the third hollow cylinder for receiving the rims of the two cups when the two cups are accommodating therein.

According to one embodiment of the present disclosure, the third hollow cylinder has a slant inner surface.

According to one embodiment of the present disclosure, the first and second materials are independently paper or plastic.

According to one embodiment of the present disclosure, the present press device is characterized in not having any alignment structure for positioning the two cups.

In another aspect, the present disclosure is directed to a method for coupling two cups respectively made of a first and a second materials by utilizing the present press device set forth above, wherein one of the two cups has a tab extending from the rim thereof. The method comprises steps of: (a) placing the two cups into the third hollow cylinder of the press device with the cup having a tab being stacked on top of the cup that does not have the tab, thereby forming stacked cups; (b) pushing the stacked cups of step (a) up with the push rod of the press device, until the stacked cups come into contact with the flange of the second hollow cylinder of the press device, such that the tab is retracted and substantially extends downward, and the rims and portions of the cup bodies of the stacked cups are accommodated in the space between the first and second hollow cylinders; (c) vertically punching the second hollow cylinder of the press device down until the rims of the stacked cups of step (b) touch the curling groove of the third hollow cylinder; and (d) curling the rims of the stacked cups of step (c) via simultaneously applying a downward force from the second hollow cylinder and an upward force from the push rod, thereby coupling the stacked cups together by forming a curled rim therebetween.

According to one embodiment of the present disclosure, in step (b) of the present method, the stacked cups are not in contact with the third hollow cylinder when the rims and portions of the cup bodies of the stacked cups are accommodated in the space between the first and second hollow cylinders.

According to one embodiment of the present disclosure, in step (c) of the present method, the second hollow cylinder moves vertically and independently inside the first hollow cylinder

According to one embodiment of the present disclosure, in step (c) of the present method, the stacked cups are held by the push rod.

According to one embodiment of the present disclosure, in step (d) of the present method, when curling the rim of the stacked cups, the tab is fixed in the curled rim of the stacked cups.

According to one embodiment of the present disclosure, the present method is characterized by excluding rotating or positioning the stacked cups before, after, or in step (a).

According to some embodiments of the present disclosure, the first and second materials are independently paper or plastic. In one preferred embodiment, the cup having the tab is made of plastic, and the other cup that does not have the tab is made of paper.

Many of the attendant features and advantages of the present disclosure will becomes better understood with reference to the following detailed description considered in connection with the accompanying drawings.

### BRIEF DESCRIPTION OF THE DRAWINGS

The present description will be better understood from the following detailed description read in light of the accompanying drawings, where:

FIG. 1A is a perspective view of an exemplary press device 1 according to one embodiment of the present disclosure;

FIG. 1B is a sectional view of the press device 1 of FIG. 1A;

FIGS. 2A to 2H are schematic diagrams respectively illustrating the positional states of the exemplary press device 1 performing the coupling method according to one embodiment of the present disclosure, wherein FIG. 2A is a perspective view depicting the stacked cups A, and the upper and lower molds (11 and 12) of the press device 1 at the initial position; FIG. 2B is a cross-sectional view of FIG. 2A; FIG. 2C is a perspective view depicting the push rod 122 pushing the stacked cups A up; FIG. 2D is a cross-sectional view of FIG. 2C; FIG. 2E is a perspective view depicting the upper mold 11 at the position of moving downward; FIG. 2F is a cross-sectional view of FIG. 2E; FIG. 2G is a perspective view depicting the upper and lower molds (11 and 12) press together to form a curled rim for the stacked cups A; and FIG. 2H is a cross-sectional view of FIG. 2G; and

FIG. 3 is a schematic diagram illustrating a press device 2 in accordance with an alternative embodiment of the present disclosure.

In accordance with common practice, the various described features/elements are not drawn to scale but instead are drawn to best illustrate specific features/elements relevant to the present invention. Also, like reference numerals and designations in the various drawings are used to indicate like elements/parts.

### DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example.

However, the same or equivalent functions and sequences may be accomplished by different examples.

### 1. Definition

For convenience, certain terms employed in the specification, examples and appended claims are collected here. Unless defined otherwise, all technical and scientific terms used herein have the same meaning as commonly understood by one of the ordinary skill in the art to which this invention belongs.

The singular forms “a”, “and”, and “the” are used herein to include plural referents unless the context clearly dictates otherwise.

The term “hollow cylinder” used herein refers to encompass a hollow structure having long sides and a hollow end with various shapes, including but are not limited to, a round, a triangle, a quadrilateral, and a polygon. According to the present disclosure, the hollow cylinder is in a circular shape to confirm the shape of a circular cup.

The term “stacked cups” as used herein refers to the status of two cups being stacked together and kept inside the press device until being coupled together by the present method. Note that the stacked cups do not separate from each other throughout the entire coupling process of this invention.

The term “rimming” and “curling” are used interchangeably herein and refer to the step in the present process of producing disposable or recyclable cups that involves rolling the edge of the cup outward and downward to form a curved arc-shaped structure that enhances the structural strength of the cup. According to the present disclosure, the “rimming” or “curling” step is performed simultaneously on two stacked cups, so that the two edges of the stacked cups overlap and are curled together to secure the two cups together.

The term “disposable cup” refers to cups that are usually designed for single use and made from disposable materials, e.g., polyethylene terephthalate (PET), polypropylene (PP), polystyrene (PS), paper, and the like. However, the use of the term “disposable” does not mean that the cup must only be a single-use cup nor preclude the possibility of the material being recyclable. According to the present disclosure, the “disposable material” referred herein is substantially recyclable.

The term “alignment structure” as used herein refers to any structure or design on a press device that helps positioning the tab (i.e., positioning the tab in a specific orientation). Examples of alignment structures include, but are not limited to, pins and dowels, tabs and notches, guide rails and tracks, optical alignment features (e.g., light or laser beams), and the like. Note that the present press device does not include any of the above-mentioned structures.

### 2. Description of The Invention

The present disclosure aims to provide an improved press device for coupling two cups. The present press device is specifically designed for vertically aligning and coupling two cups stacked together and respectively made of different materials, i.e., a first and a second materials, in order to form a double-walled cup. Notably, the press device does not include any alignment structure for positioning the two cups, accordingly, the present press device may produce double wall cups in a timely manner. Also provided herein is a method for coupling two cups by utilizing the aforementioned press device.

### 2.1 the Press Device

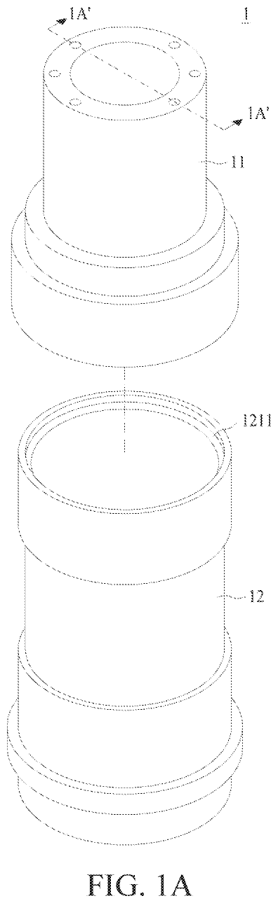

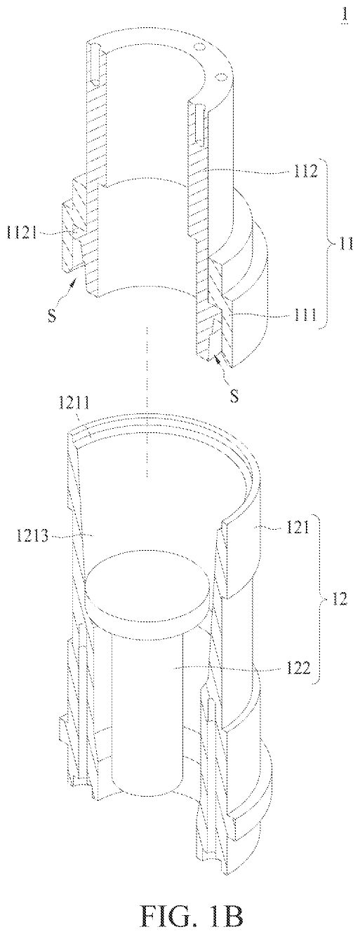

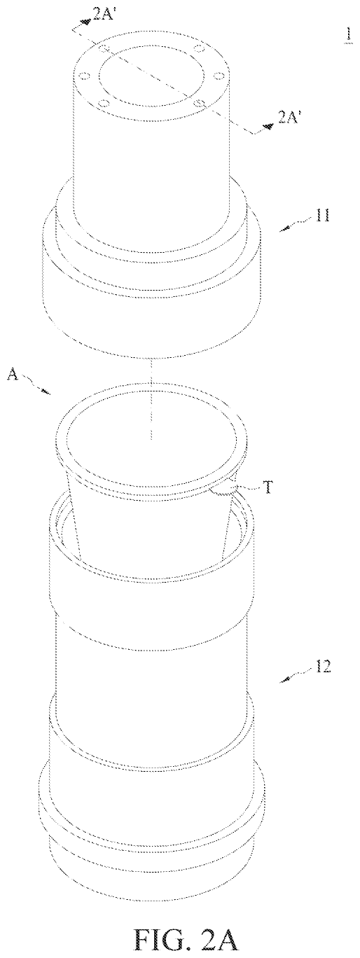

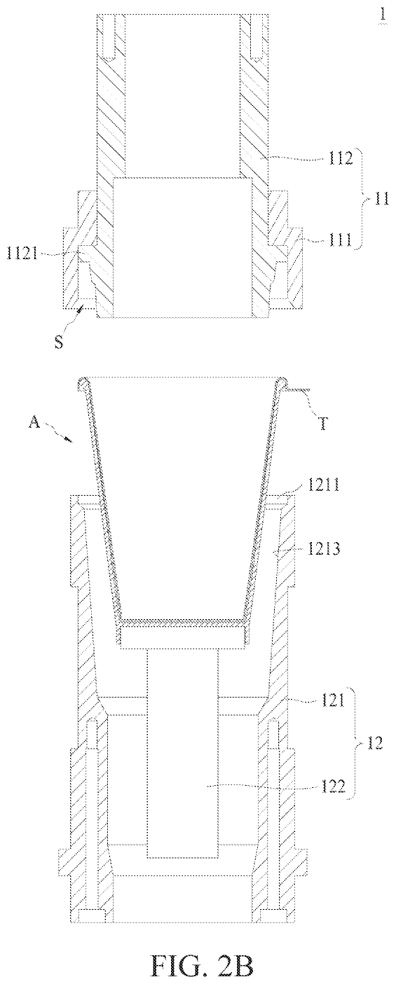

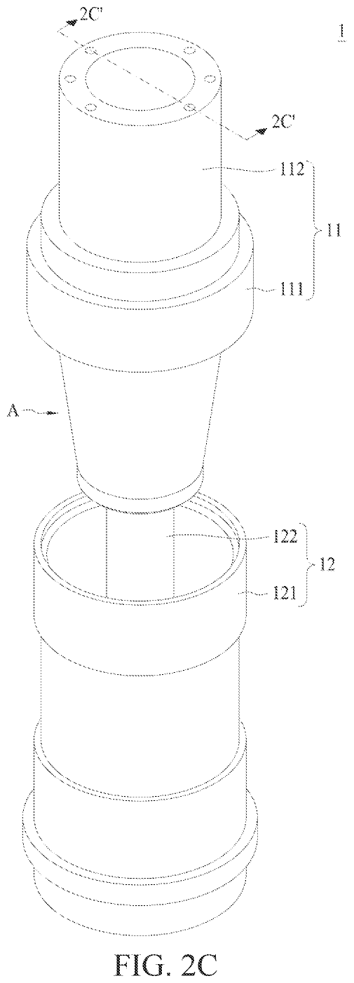

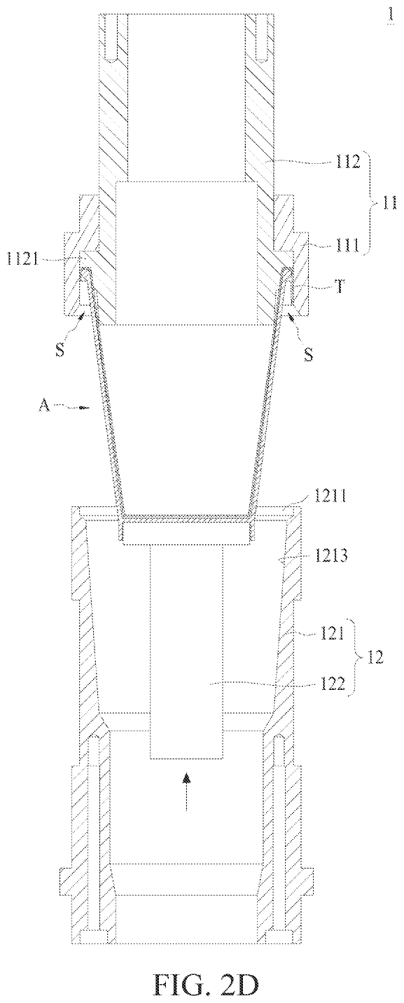

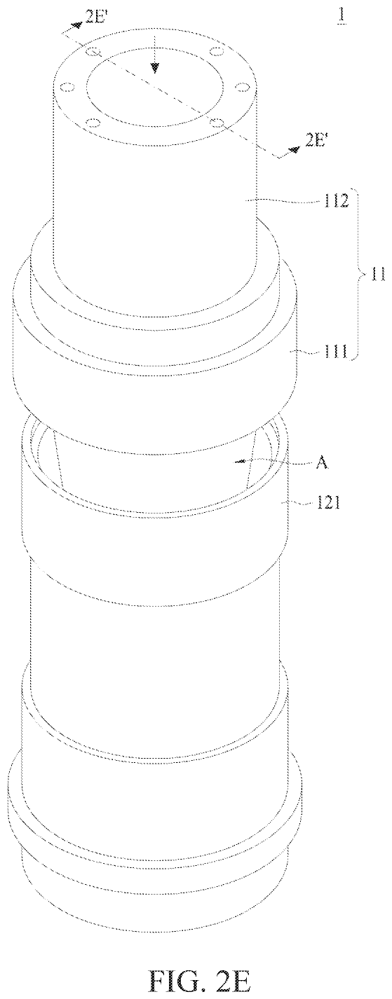

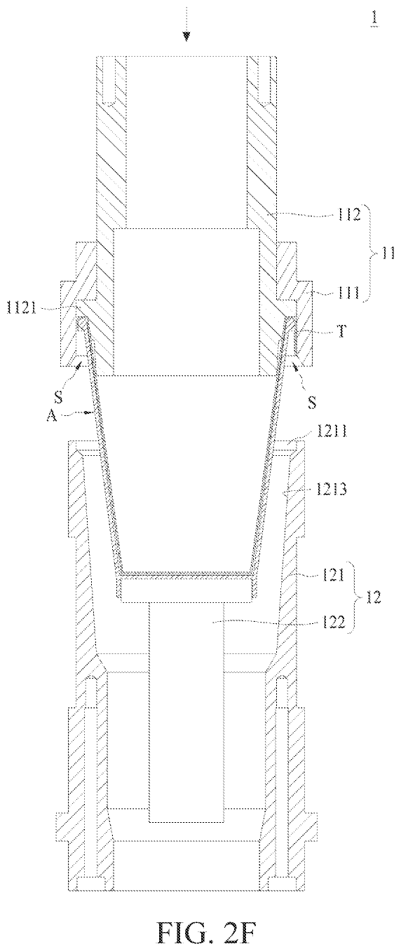

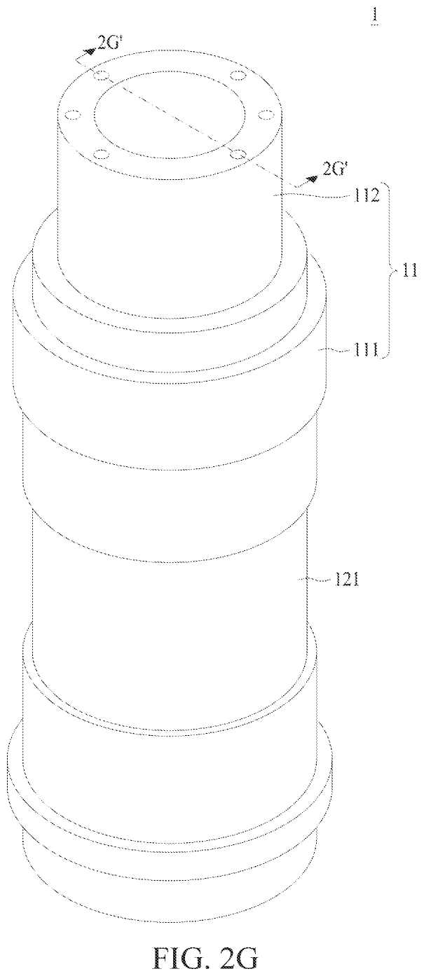

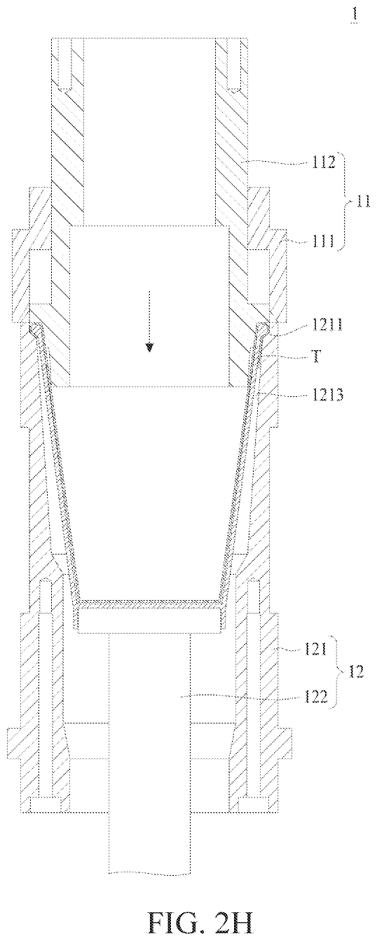

Reference is now made to FIGS. 1A and 1B, which are respectively the perspective and cross-sectional views of a press device 1 according to one aspect of the present disclosure. The press device 1 comprises an upper mold 11 and a lower mold 12, in which the upper and lower molds (11 and 12) are vertically aligned and spaced apart by a certain distance. The upper mold 11 comprises in its structure, a first hollow cylinder 111, and a second hollow cylinder 112, in which the second hollow cylinder 112 has a flange 1121 protruding out from its outer surface. As depicted, the second hollow cylinder 112 is preferably disposed inside the first hollow cylinder 111, so that the flange 1121 of the second hollow cylinder 112 comes into contact with the inner surface of the first hollow cylinder 111, thereby creating a space S between them during operation. Preferably, the size of the space S can be varied or adjusted according to the need as long as the stacked cups are held therein during the coupling process. According to preferred embodiments, the depth of the space S is greater than the length of the cup's tab, which is described in further detail in FIGS. 2A-2H.

Similarly, the lower mold 12 comprises, in its structure, a third hollow cylinder 121 and a push rod 122, which is centrally disposed within the third hollow cylinder 121 and moves independently and vertically inside the third hollow cylinder 121. In addition, the third hollow cylinder 121 further comprises a curling groove 1211 disposed at and around its top edge, as depicted in FIG. 1B. According to embodiments of the present disclosure, the size (i.e., depth and width) of the curling groove 1211 can be varied or adjusted according to the practical needs, for example, based on the shapes or sizes of the rims of the cups, in the purpose of providing a normal force on the rims of the cups and preventing the two cups from slipping out of the device during coupling process. According to some alternative embodiments of the present disclosure, the third hollow cylinder 121 may have a slant inner surface 1213 (FIG. 1B), which better conforms to the shape of the cups and provides sufficient support.

The press device 1 of the present disclosure invention can be driven by mechanisms well known in the art, such as the forces generated by hydraulic cylinders and hydraulic fluids (i.e., hydraulic force), the forces generated by mechanical systems like a flywheel and a crankshaft (i.e., mechanical force), or the forces generated by compressed air (i.e., pneumatic force), to move the upper and lower molds (11, 12) of the press device 1, thereby achieving desired results.

### 2.2 the Coupling Process

Another aspect of the present disclosure is directed to coupling two cups with the aid of the press device 1. References are now made to FIGS. 2A to 2H, which collectively illustrate the states of the present press device 1 during the pressing or coupling process.

FIG. 2A depicts the upper and lower molds (11 and 12) respectively at their initial or at-rest positions (i.e., the positions before the pressing process commences), and FIG. 2B is a cross-sectional view of the press device 1 of FIG. 2A. Note that in this at-rest position, such as depicted in FIGS. 2A and 2B, the push rod 122 in the third hollow cylinder 121 of the lower mold 12 is in a relatively lower position. By this arrangement, the third hollow cylinder 121 will have enough room to receive and hold cups therein.

To start the coupling process, two cups respectively made of a first and a second materials are stacked to form stacked cups (denoted as “A” in FIGS. 2A-2H), in which one cup having a tab (denoted as “T” in FIGS. 2A-2H) (e.g., a plastic cup) is placed on top of another cup without the tab (e.g., a paper cup). The stacked cups A are then placed into the third hollow cylinder 121 above the push rod 122 (FIG. 2B). Preferably, the stacked cups A are placed into the third hollow cylinder 121 above the push rod 122 with the rims of the stacked cups A being supported or upheld by the curling groove 1211 of the third hollow cylinder 121.

References are now made to FIGS. 2C and 2D, in which FIG. 2C is a perspective view of the press device 1 in motion, while FIG. 2D is a cross-sectional view of the press device 1 in FIG. 2C. At this stage, the push rod 122 moves vertically up in relative to the third hollow cylinder 121, thereby pushing the stacked cups A into the space S created between the flange 1121 and the inner surface of the first hollow cylinder 111. The space S may accommodate at least the rims and the portions of the cup bodies of the stacked cups A, in which the flange 1121 typically comes into contact with the rims, and the tab T is retracted downwardly to contact with the inner surface of the first hollow cylinder 111 (FIG. 2D), note that at this point, the tab T is substantially perpendicular to the ground. The upward movement of the push rod 122 automatically stops when the top edge of the stacked cups A contacts the flange 1121 of the second hollow cylinder 112. Through this operation, the tab T is retracted into the space S and confined to substantially extends downward. Typically, after pushing up the stacked cups A, the rims and the portions of the cup bodies of the stacked cups A are accommodated in the space S between the first and second hollow cylinders (111 and 112), as illustrated in FIGS. 2C and 2D. Note that at this stage, the stacked cups A are substantially away from the third hollow cylinder 121, in other words, the stacked cups A are no longer in contact with the third hollow cylinder 121.

References are now made to FIGS. 2E to 2H, in which FIGS. 2E and 2G are perspective views of the upper mold 11 of the press device 1 in a pressing-down position, while FIGS. 2F and 2H are the cross-sectional views of the press device 1 in FIGS. 2E and 2G, respectively. As depicted in FIG. 2D, once the tab T of the stacked cups A is retracted, the upper mold 11 may then proceed to punch down until it comes into contact with the lower mold 12 (FIG. 2G), specifically, until the first hollow cylinder 111 contacts the third hollow cylinder 121. At this point, the first hollow cylinder 111 is relatively fixed at certain position, and the second hollow cylinder 112 continues to press further down (i.e., in relative to the first hollow cylinder 111) to push the stacked cups A out of the space S until the rims of the stacked cups A touch the curling groove 1211 of the third hollow cylinder 121. According to some preferred embodiments, the push rod 122 of the present press device 1 do not detach from the bottom of the stacked cups A during the upper mold 11 is pressing down.

Once the rims of the stacked cups A are positioned in the curling groove 1211 of the third hollow cylinder 121, the second hollow cylinder 112 continues to apply a downward force, while the push rod 122 simultaneously applies an upward force, causing the rims of the stacked cups A to curl and form a curled rim thereby coupling the two cups together (FIG. 2H). According to preferred embodiments of the present disclosure, some portion of the tab T retracted and confined to extend downwards as set forth above is fixed within the curled rims of the stacked cups A. while the other portion of the tab T remains outwardly and vertically extended, which serves as a pulling point, allowing the user to grape and pull the tab T upward to separate the two cups (i.e., the inner and the outer cups). In an alternative preferred embodiment, when the tab T is secured to the curled rims of the stacked cups A, the outward portion of the tab T is attached and adhered to the outer surface of the cup that does not have the tab (i.e., the outer cup) (FIG. 2H).

It should be noted that the present press device does not include any alignment structure, which eliminates the need for rotating or positioning the stacked cups during the operation of the present method.

According to embodiments of the present disclosure, the first and second materials of the cups are disposable or recyclable materials, such as plastic, paper, foam, and the like. Preferably, the first and second materials are independently paper or plastic; more preferably, the cup having a tab extending from the rim is made of plastic, and the other cup having no tab is made of paper. Examples of plastic materials suitable for manufacturing the cup include, but are not limited to, polyethylene (PE, including ultra-low density polyethylene (ULDPE) and very low density polyethylene (VLDPE)), polypropylene (PP), polystyrene (PS), polyvinyl chloride (PVC), polycarbonate (PC), Nylon, polyethylene terephthalate (PET), polytetrafluoroethylene (PTFE), polyurethane (PU), acrylonitrile-butadiene styrene (ABS), and a combination thereof. In working example, the cup with a tab is made of PP.

Note that the shape of the cups or containers applicable to the present press device for the coupling process is not limited to the circular shape as depicted in FIGS. 2A to 2H. Examples of the container's (e.g., a cup) shape include, but are not limited to, triangles, squares and polygons.

By virtue of the foregoing, the coupling process of the present disclosure enables the simultaneous positioning, rimming and tab fixing of the inner and outer cups within a single operation cycle.

### 2.3 the Alternative Design of the Present Press Device

Alternatively, or in addition, a plurality of the press device 1 described above in FIGS. 1A to 2H may be assembled to form a press device 2 for coupling multiple sets of stacked cups simultaneously.

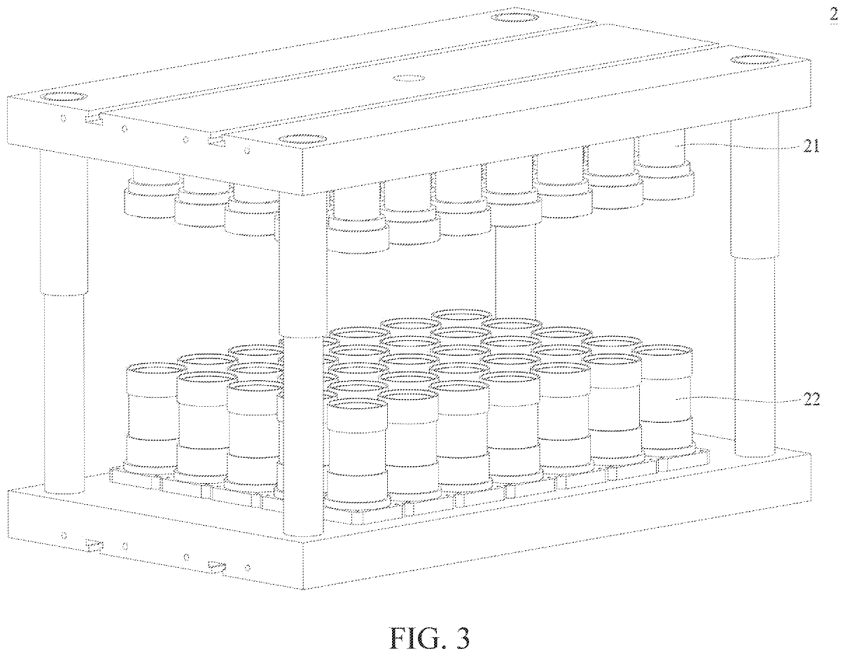

Reference is made to FIG. 3, in which a plurality of vertically aligned upper and lower molds (21, 22) are assembled into the press device 2. The number of the upper and lower molds (21 and 22) of the press device 2 can be varied according to practical needs. In the depicted example of FIG. 3, the press device 2 comprises two panels of upper and lower molds (21 and 22), in which each panel consists of 35 upper or lower molds (21 and 22) arranged in a 5×7 matrix, allowing simultaneously coupling of 35 sets of stacked cups. Higher number sets of stacked cups may be coupled if needed.

Since the space (not illustrated) defined within each of the upper mold 21 can retract the tabs of the stacked cups with different orientations when they are placed in the lower mold 22, the present press device 2 does not need any alignment structure. Furthermore, the misalignment of the tabs does not affect the smooth progress of the coupling process. Accordingly, the device and method of present disclosure may couple stacked cups within a short period of time, for example, the entire process may be completed within 10, 9, 8, 7, 6, 5, 4, 3, 2, or 1 second(s); preferably, with 1 to 4 second(s).

In view of the foregoing, by using the press device of the present disclosure, two cups made of different materials, especially those with irregular rims and protruding tabs, may be smoothly and seamlessly coupled within seconds without the need to align them before the coupling. Additionally, since rotating or positioning the cups is not required, the number of molds can be set according to practical needs, thereby significantly improving the efficiency of the coupling process.

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A press device comprising an upper mold and a lower mold that are vertically aligned for coupling two cups respectively made of a first and a second materials and stacked together to form a double-walled cup after pressing, wherein,
the upper mold comprises,
a first hollow cylinder; and
a second hollow cylinder that moves vertically and independently inside the first hollow cylinder; and
the lower mold comprises
a third hollow cylinder that accommodates and holds the two cups; and
a push rod disposed at the center of the third hollow cylinder for pushing up the two cups,
wherein,
the second hollow cylinder has a flange protruding from the outer surface of the second hollow cylinder and contacting the inner surface of the first hollow cylinder, thereby defining a space therebetween for accommodating at least the rims and portions of the cup bodies of the two cups; and
the third hollow cylinder has a curling groove disposed at and around the top edge of the third hollow cylinder for receiving the rims of the two cups when the two cups are accommodating therein.

2. The press device of claim 1, wherein the third hollow cylinder has a slant inner surface.

3. The press device of claim 1, wherein the first and second materials are independently paper or plastic.

4. The press device of claim 1, wherein the press device is characterized in not having any alignment structure for positioning the two cups.

5. A method for coupling two cups respectively made of a first and a second materials by utilizing the press device of claim 1, wherein one of the two cups has a tab extending from the rim thereof, the method comprises steps of:
(a) placing the two cups into the lower mold of the press device with the cup having a tab being stacked on top of the other cup that does not have the tab thereby forming stacked cups;
(b) pushing the stacked cups of step (a) up with the push rod of the press device, until the stacked cups come into contact with the flange of the second hollow cylinder of the press device, such that the tab is retracted and substantially extends downward, and the rims and portions of the cup bodies of the stacked cups are accommodated in the space between the first and second hollow cylinders;
(c) vertically punching the second hollow cylinder of the press device down until the rims of the stacked cups of step (b) touch the curling groove of the third hollow cylinder; and
(d) curling the rims of the stacked cups of step (c) via simultaneously applying a downward force from the second hollow cylinder and an upward force from the push rod, thereby coupling the stacked cups together by forming a curled rim therebetween.

6. The method of claim 5, wherein in step (b), the stacked cups are not in contact with the third hollow cylinder when the rims and portions of the cup bodies of the stacked cups are accommodated in the space between the first and second hollow cylinders.

7. The method of claim 5, wherein in step (c), the second hollow cylinder moves vertically and independently inside the first hollow cylinder.

8. The method of claim 5, wherein in step (c), the stacked cups are held by the push rod.

9. The method of claim 5, wherein in step (d), when curling the rim of the stacked cups, the tab is fixed in the curled rim of the stacked cups.

10. The method of claim 5, wherein the method does not comprise rotating or positioning the stacked cups before, after, or in step (a).

11. The method of claim 5, wherein the first and second materials are independently paper or plastic.

12. The method of claim 5, wherein the cup having the tab is made of plastic and the other cup that does not have the tab is made of paper.
